(19) United States
(12) Patent Application Publication
(10) Pub. No.: US 2010/0151436 A1
(43) Pub. Date: Jun. 17, 2010

(54) Methods for Ex Vivo Administration of Drugs to Grafts Using Polymeric Nanoparticles

(76) Inventors: Peter M. Fong, New York, NY (US); William Mark Saltzman, New Haven, CT (US); Tarek M. Fahmy, New Haven, CT (US)

Correspondence Address: Pabst Patent Group LLP, 1545 PEACHTREE STREET NE, SUITE 320, ATLANTA, GA, 30309, US

(21) Appl. No.: 12/528,679

(22) PCT Filed: Feb. 28, 2008
(86) PCT No.: PCT/US08/55313

§ 371 Date: Jan. 27, 2010

(51) Int. Cl. A01N 1/02

(52) U.S. Cl. 435/1.1

(57) ABSTRACT

Methods for ex vivo administration of drugs to grafts using polymeric micro- and nanoparticles and applications for these methods are described herein. The particles contain encapsulated molecules which are released locally at the site of implantation and function to prevent graft rejection or aid in the proper adaptation of the graft to the host. The disclosed methods may be used to inhibit or reduce hyperplasia and stenosis of vascular grafts or to prevent graft rejection.

### CROSS REFERENCE TO RELATED APPLICATIONS

This application claims priority to and benefit of Provisional U.S. Patent Application No. 60/892,658 filed on Mar. 2, 2007.

### STATEMENT REGARDING FEDERALLY FUNDED RESEARCH

This invention was made with government support awarded by the National Institutes of Health under Grant Nos. 1030899, 1A05838, 656001, NS45236, and DK070068. The United States Government has certain rights in this invention.

### FIELD OF THE INVENTION

The present disclosure generally relates to the field of methods and nanoparticulate compositions for ex vivo administration of drugs to tissues and organs for transplantation.

### BACKGROUND OF THE INVENTION

Tissue and organ transplantation is a major life-saving strategy, thanks to advances in surgical technique over the past 50 years. Recent progress in immunosuppression has also served to improve graft survival and patient health, making transplantation more common. Still, allografts do not always survive and many patients experience life-threatening side effects from the powerful drugs that are used to prevent tissue rejection. Autografts do not always adapt to their new location, and can in some cases adapt improperly, such as when venous bypasses in the coronary artery experience neointimal hyperplasia and stenosis. Arterial restenosis is the occlusion or constriction of an artery after prior opening by surgical procedure. Neointimal hyperplasia, the proliferation of vascular smooth muscle cells, is a major contributor to vessel restenosis and the principal cause of failure in late bypass grafts and arteriovenous graft fistulas used for permanent renal dialysis access. Other types of grafts including xenografts, synthetic grafts and tissue engineered grafts suffer from similar problems of rejection and improper adaptation.

Toxicity and insufficient efficacy have been a limitation in the systemic administration of drugs to inhibit graft rejection and disorders such as restenosis (Labhasetwar, Advanced Drug Delivery Reviews, 24:63-85 (1997)). This is highlighted by the large systemic doses needed to achieve a sufficient local concentration at the site of therapy. For this reason, researchers began developing methods to deliver potentially useful molecules to the vascular location being treated. Edelman and colleagues demonstrated the inhibition of restenosis by local drug delivery in 1990. In their experiments, they showed that releasing heparin from ethylene-vinyl acetate (EVAc) copolymer disks positioned adjacent to the site of injury was more effective in preventing smooth muscle cell proliferation than distally releasing heparin with the same vehicle, systemic IV infusion of free heparin or placebo in a rat model (Edelman, et al., Proc. Natl. Acad. Sci. U.S.A., 87(10):3773-7 (1990)). In 1995, Dev and co-authors used removable polymer-coated stents to deliver C¹⁴-labeled etretinate and H³-labeled forskolin to the vessel wall in rabbits and evaluated the kinetics of drug distribution (Dev, et al., Cathet. Cardiovasc. Diagn., 34(3):272-S (1995)). In 1997, the same author treated the vascular wall of pigs with rhodamine and dexamethasone loaded particles by surgically inducing particle infusion with a balloon. The rhodamine microspheres confirmed particle impregnation of the vascular wall while histology revealed a reduction in hyperplasia by dexamethasone (Dev, et al., Cathet. Cardiovasc. Diagn., 41(3):324-32 (1997)). Around the same time, Humbhrey and others were using a similar technique to deliver the antiproliferative 2-aminochromone U-86983 in nanoparticles to the porcine vascular wall (Humphrey, Advanced drug Delivery Reviews, 24:87-108 (1997)). Other work has shown that infusion of N-isoproplyacrylamide and N-vinyl pyrrolidone nanoparticles into the vascular wall of rats under positive pressure after carotid balloon insertion and ligation inhibits neointimal hyperplasia. All of these approaches involve in vivo surgical placement of the delivery device, oftentimes forcibly with abrasive surgical instrumentation.

It is therefore an object of the invention to provide methods for preventing or reducing rejection of allografts, autografts, xenografts, synthetic grafts and tissue engineered grafts without the requirement for invasive in vivo surgical placement of a drug delivery device.

It is another object of the invention to provide methods for local delivery of drugs in a controlled fashion to graft sites at the time of implantation.

It is yet another object of the invention to provide applications for using these methods.

### SUMMARY OF THE INVENTION

Methods for ex vivo administration of drugs to grafts using polymeric nanoparticles and applications for these methods are disclosed herein. These methods involve direct application of nanoparticles to graft materials prior to implantation in a host. The polymeric nanoparticles can have ligands which facilitate attachment of the nanoparticles to the graft and/or ligands which target the polymeric nanoparticles to specific cell or tissue types. Ligands may be directly attached to the polymer or may be attached to an adaptor element which associates with the polymeric nanoparticle. Ligands may be attached to adaptor elements directly via covalent bonds, or indirectly through an interaction between two molecules which form highly-specific, non-covalent physiochemical interactions. Molecules which prevent graft rejection or aid in the proper adaptation of the graft into the host can be encapsulated in or attached to the surface of the polymeric particle. Preferred molecules are anti-inflammatory, anti-proliferative and immuno-suppressant drugs.

The graft material is coated with drug-loaded particles ex vivo prior to implantation. The amount of attached nanoparticles can be controlled by varying the amount of nanoparticles incubated with the graft and by varying the incubation conditions. Incubation may occur in the absence or presence of mild agitation. The disclosed methods can also be used to prevent rejection of grafts by allowing for the local release of immuno-suppressive factors at the site of implantation.

These methods also may be used to inhibit hyperplasia and stenosis or other maladaptation of vascular grafts including bypass grafts and arteriovenous grafts. The methods allow for the local controlled release of anti-restenotic factors at the site of grafting without the requirement for further invasive procedures.

### BRIEF DESCRIPTION OF THE DRAWINGS

FIG. 1A is a graph demonstrating the cumulative controlled release of rapamycin (μg) from nanoparticles over time (days) in phosphate buffered saline at 25° C. Each point is the average of triplicate samples.

FIG. 1B is a graph demonstrating the two-week inhibition of interferon gamma secretion from peripheral blood mononuclear cells by rapamycin-eluting nanoparticles in cell culture over time (in days).

FIG. 2 is a bar graph demonstrating the amount (μg) of avidin-coated and non-coated nanoparticles attached to vascular tissue after coating tissue segments of two different sizes (30 mm² and 10 mm²).

FIG. 3 is a bar graph demonstrating the amount (mg) of avidin-coated microparticles (40 μm) and avidin-coated nanoparticles (200 nm) attached to vascular tissue (8 mm²) following incubation.

FIG. 4 is a bar graph demonstrating the amount (mg) of avidin-coated nanoparticles attached to vascular tissue (15 mm²) following incubation with either no agitation or gentle agitation using either an orbital shaker or vertical rotation.

### DETAILED DESCRIPTION OF THE INVENTION

### I. Definitions

As used herein, a “graft” is a tissue for transplantation. This may be in the form of cells or non-dissociated tissue. It may or may not have been treated prior to implantation to sterilize, modify, or cleanse the graft. Grafts include autograft and allograft tissues and organs, tissues produced by tissue engineering and non-biological medical devices by attachment of specific ligands (i.e. counter ligands attached to each surface) or by electrostatic or other non-covalent means. An example of this is the incubation of a positively charged, polylysine-coated silicone material in negatively charged nanoparticles.

As used herein, a “microparticle” is particle having a diameter between one micron and 1000 microns, typically less than 400 microns, more typically less than 100 microns, most preferably for the uses described herein in the range of less than 10 microns in diameter. Microparticles include microcapsules and microspheres unless otherwise specified.

As used herein, “nanoparticles” refer to particles having a diameter of less than one micron, more typically between 50 and 1000 nanometers, preferably in the range of 100 to 300 nanometers. As used herein, the preferred nanoparticles are the smaller sizes to encourage tissue penetration.

As used herein, “ligands” refer to molecules which may be protein, polysaccharide, saccharide, lipid, glycolipid, nucleic acid, or combinations thereof, which specifically bind to a target molecule. Ligands may be of varying specificity such as those that bind to particular receptors, antibody-antigen reactions, or avidin or strepavidin with biotin.

As used herein, “implantation” refers to placement of a graft within the body. This may be by surgical means or minimally invasive means such as a catheter or by injection or infusion into a tissue, in the case of cells or minced tissue.

Cells and tissues to be treated are referred to herein as “tissue” unless otherwise specified.

### II. Micro and Nanoparticulate Formulations

A. Polymeric Micro- and Nanoparticles

i. Polymers

Non-biodegradable or biodegradable polymers may be used to form the microparticles. In the preferred embodiment, the microparticles are formed of a biodegradable polymer. In general, synthetic polymers are preferred, although natural polymers may be used and have equivalent or even better properties, especially some of the natural biopolymers which degrade by hydrolysis, such as some of the polyhydroxyalkanoates. Representative synthetic polymers include poly(hydroxy acids) such as poly(lactic acid), poly(glycolic acid), and poly(lactic acid-co-glycolic acid), poly(lactide), poly(glycolide), poly(lactide-co-glycolide), polyanhydrides, polyorthoesters, polyamides, polycarbonates, polyalkylenes such as polyethylene and polypropylene, polyalkylene glycols such as poly(ethylene glycol), polyalkylene oxides such as poly(ethylene oxide), polyalkylene terepthalates such as poly(ethylene terephthalate), polyvinyl alcohols, polyvinyl ethers, polyvinyl esters, polyvinyl halides such as poly(vinyl chloride), polyvinylpyrrolidone, polysiloxanes, poly(vinyl alcohols), poly(vinyl acetate), polystyrene, polyurethanes and co-polymers thereof, derivativized celluloses such as alkyl cellulose, hydroxyalkyl celluloses, cellulose ethers, cellulose esters, nitro celluloses, methyl cellulose, ethyl cellulose, hydroxypropyl cellulose, hydroxy-propyl methyl cellulose, hydroxybutyl methyl cellulose, cellulose acetate, cellulose propionate, cellulose acetate butyrate, cellulose acetate phthalate, carboxylethyl cellulose, cellulose triacetate, and cellulose sulfate sodium salt (jointly referred to herein as “synthetic celluloses”), polymers of acrylic acid, methacrylic acid or copolymers or derivatives thereof including esters, poly(methyl methacrylate), poly(ethyl methacrylate), poly(butylmethacrylate), poly(isobutyl methacrylate), poly(hexylmethacrylate), poly(isodecyl methacrylate), poly(lauryl methacrylate), poly(phenyl methacrylate), poly(methyl acrylate), poly(isopropyl acrylate), poly(isobutyl acrylate), and poly(octadecyl acrylate) (jointly referred to herein as “polyacrylic acids”), poly(butyric acid), poly(valeric acid), and poly(lactide-co-caprolactone), copolymers and blends thereof. As used herein, “derivatives” include polymers having substitutions, additions of chemical groups and other modifications routinely made by those skilled in the art.

Examples of preferred biodegradable polymers include polymers of hydroxy acids such as lactic acid and glycolic acid, and copolymers with PEG, polyanhydrides, poly(ortho)esters, polyurethanes, poly(butyric acid), poly(valeric acid), poly(lactide-co-caprolactone), blends and copolymers thereof.

Examples of preferred natural polymers include proteins such as albumin, collagen, gelatin and prolamines, for example, zein, and polysaccharides such as alginate, cellulose derivatives and polyhydroxyalkanoates, for example, poly 4-hydroxybutyrate copolymers. The in vivo stability of the microparticles can be adjusted during the production by using polymers such as poly(lactide-co-glycolide) copolymerized with polyethylene glycol (PEG). If PEG is exposed on the external surface, it may increase the time these materials circulate due to the hydrophilicity of PEG.

Examples of preferred non-biodegradable polymers include ethylene vinyl acetate, poly(meth)acrylic acid, polyamides, copolymers and mixtures thereof.

In a preferred embodiment, PLGA is used as the biodegradable polymer.

The micro- and nanoparticles are designed to release molecules to be encapsulated or attached over a period of days to weeks. Factors that affect the duration of release include pH of the surrounding medium (higher rate of release at pH 5 and below due to acid catalyzed hydrolysis of PLGA) and polymer composition. Aliphatic polyesters differ in hydrophobicity and that in turn affects the degradation rate. Specifically, the hydrophobic poly (lactic acid) (PLA), more hydrophilic poly (glycolic acid) PGA and their copolymers, poly (lactide-co-glycolide) (PLGA) have various release rates. The degradation rate of these polymers, and often the corresponding drug release rate, can vary from days (PGA) to months (PLA) and is easily manipulated by varying the ratio of PLA to PGA.

ii. Formation of Micro- and Nanoparticles

Many different processes can be used to form the micro- or nanoparticles. If the process does not produce particles having a homogeneous size range, then the particles can be separated using standard techniques such as sieving to produce a population of particles having the desired size range.

a. Solvent Evaporation. In this method the polymer is dissolved in a volatile organic solvent, such as methylene chloride. The drug (either soluble or dispersed as fine particles) is added to the solution, and the mixture is suspended in an aqueous solution that contains a surface active agent such as poly(vinyl alcohol). The resulting emulsion is stirred until most of the organic solvent evaporated, leaving solid microparticles. The resulting microparticles are washed with water and dried overnight in a lyophilizer. Microparticles with different sizes (0.5-1000 microns) and morphologies can be obtained by this method. This method is useful for relatively stable polymers like polyesters and polystyrene.

However, labile polymers, such as polyanhydrides, may degrade during the fabrication process due to the presence of water. For these polymers, the following two methods, which are performed in completely anhydrous organic solvents, are more useful.

b. Hot Melt Microencapsulation. In this method, the polymer is first melted and then mixed with the solid particles. The mixture is suspended in a non-miscible solvent (like silicon oil), and, with continuous stirring, heated to 5° C. above the melting point of the polymer. Once the emulsion is stabilized, it is cooled until the polymer particles solidify. The resulting microparticles are washed by decantation with petroleum ether to give a free-flowing powder. Microparticles with sizes between 0.5 to 1000 microns are obtained with this method. The external surfaces of spheres prepared with this technique are usually smooth and dense. This procedure is used to prepare microparticles made of polyesters and polyanhydrides. However, this method is limited to polymers with molecular weights between 1,000-50,000.

c. Solvent Removal. This technique is primarily designed for polyanhydrides. In this method, the drug is dispersed or dissolved in a solution of the selected polymer in a volatile organic solvent like methylene chloride. This mixture is suspended by stirring in an organic oil (such as silicon oil) to form an emulsion. Unlike solvent evaporation, this method can be used to make microparticles from polymers with high melting points and different molecular weights. Microparticles that range between 1-300 microns can be obtained by this procedure. The external morphology of spheres produced with this technique is highly dependent on the type of polymer used.

d. Spray-Drying. In this method, the polymer is dissolved in organic solvent. A known amount of the active drug is suspended (insoluble drugs) or co-dissolved (soluble drugs) in the polymer solution. The solution or the dispersion is then spray-dried. Typical process parameters for a mini-spray drier (Buchi) are as follows: polymer concentration=0.04 g/mL, inlet temperature=−24° C., outlet temperature=13-15° C., aspirator setting=15, pump setting=10 mL/minute, spray flow=600 Nl/hr, and nozzle diameter=0.5 mm. Microparticles ranging between 1-10 microns are obtained with a morphology which depends on the type of polymer used.

e. Phase Inversion. Microspheres can be formed from polymers using a phase inversion method wherein a polymer is dissolved in a “good” solvent, fine particles of a substance to be incorporated, such as a drug, are mixed or dissolved in the polymer solution, and the mixture is poured into a strong non-solvent for the polymer, to spontaneously produce, under favorable conditions, polymeric microspheres, wherein the polymer is either coated with the particles or the particles are dispersed in the polymer. The method can be used to produce microparticles in a wide range of sizes, including, for example, about 100 nanometers to about 10 microns. Exemplary polymers which can be used include polyvinylphenol and polylactic acid. Substances which can be incorporated include, for example, imaging agents such as fluorescent dyes, or biologically active molecules such as proteins or nucleic acids. In the process, the polymer is dissolved in an organic solvent and then contacted with a non-solvent, which causes phase inversion of the dissolved polymer to form small spherical particles, with a narrow size distribution optionally incorporating an antigen or other substance.

f. Hydrogel Microparticles. Microparticles made of gel-type polymers, such as alginate and hyaluronic acid, are produced through traditional ionic gelation techniques. The polymers are first dissolved in an aqueous solution, mixed with barium sulfate or some bioactive agent, and then extruded through a microdroplet forming device, which in some instances employs a flow of nitrogen gas to break off the droplet. A slowly stirred (approximately 100-170 RPM) ionic hardening bath is positioned below the extruding device to catch the forming microdroplets. The microparticles are left to incubate in the bath for twenty to thirty minutes in order to allow sufficient time for gelation to occur. Microparticle particle size is controlled by using various size extruders or varying either the nitrogen gas or polymer solution flow rates. Chitosan microparticles can be prepared by dissolving the polymer in acidic solution and crosslinking it with tripolyphosphate. Carboxymethyl cellulose (CMC) microparticles can be prepared by dissolving the polymer in acid solution and precipitating the microparticle with lead ions. In the case of negatively charged polymers (e.g., alginate, CMC), positively charged ligands (e.g., polylysine, polyethyleneimine) of different molecular weights can be conically attached.

The preferred method at this time is to use solvent evaporation to form particles of a synthetic polymer.

iii. Attachment of Ligands to the Surface of Polymeric Particles which Function in Attachment and/or Targeting of the Particles

Molecules which function to enhance the attachment of polymeric micro- and nanoparticles to graft materials and molecules which function as targeting molecules can be coupled directly to the polymer or to an adaptor element such as a fatty acid which is incorporated into the polymer. Such molecules which enhance attachment and/or targeting of the micro- and nanoparticles are referred to herein as “ligands”.

Ligands may be directly attached to the surface of polymeric particles via a functional chemical group (carboxylic acids, aldehydes, amines, sulfhydryls and hydroxyls) present on the surface of the particle and present on the ligand to be attached. Functionality may be introduced post-particle preparation, by direct crosslinking of particles and ligands with homo- or heterobifunctional crosslinkers. This procedure may use a suitable chemistry and a class of crosslinkers (CDT, EDAC, glutaraldehydes, etc. as discussed in more detail below) or any other crosslinker that couples ligands to the particle surface via chemical modification of the particle surface after preparation.

Ligands may also be attached to polymeric particles indirectly though adaptor elements which interact with the polymeric particle. Adaptor elements may be attached to polymeric particles in at least two ways. The first is during the preparation of the micro- and nanoparticles, for example, by incorporation of stabilizers with functional chemical groups during emulsion preparation of microparticles. For example, adaptor elements, such as fatty acids, hydrophobic or amphiphilic peptides and polypeptides can be inserted into the particles during emulsion preparation. In a second embodiment, adaptor elements may be amphiphilic molecules such as fatty acids or lipids which may be passively adsorbed and adhered to the particle surface, thereby introducing functional end groups for tethering to ligands. Adaptor elements may associate with micro- and nanoparticles through a variety of interactions including, but not limited to, hydrophobic interactions, electrostatic interactions and covalent coupling.

In the preferred embodiment, the surface is modified to insert amphiphilic polymers or surfactants that match the polymer phase HLB or hydrophile-lipophile balance. HLBs range from 1 to 15. Surfactants with a low HLB are more lipid loving and thus tend to make a water in oil emulsion while those with a high HLB are more hydrophilic and tend to make an oil in water emulsion. Fatty acids and lipids have a low HLB below 10. After conjugation with a target group such as hydrophilic avidin, the HLB increases above 10. This conjugate is used in emulsion preparation. Any amphiphilic polymer with an HLB in the range 1-10, more preferably between 1 and 6, most preferably between 1 and up to 5, can be used. This includes all lipids, fatty acids and detergents. Other useful molecules include hydrophobic and amphipathic peptides and polypeptides.

Attachment of ligands to polymeric particles directly or indirectly through attachment to adaptor elements may be accomplished in a number of ways. One useful protocol involves the “activation” of hydroxyl groups on polymer chains with the agent, carbonyldiimidazole (CDT) in aprotic solvents such as DMSO, acetone, or THF. CDI forms an imidazolyl carbamate complex with the hydroxyl group which may be displaced by binding the free amino group of a ligand such as a protein. The reaction is an N-nucleophilic substitution and results in a stable N-alkylcarbamate linkage of the ligand to the polymer. The “coupling” of the ligand to the “activated” polymer matrix is maximal in the pH range of 9-10 and normally requires at least 24 hrs. The resulting ligand-polymer complex is stable and resists hydrolysis for extended periods of time.

Another coupling method involves the use of 1-ethyl-3-(3-dimethylaminopropyl) carbodiimide (EDAC) or “water-soluble CDT” in conjunction with N-hydroxylsulfosuccinimide (sulfo NHS) to couple the exposed carboxylic groups of polymers to the free amino groups of ligands in a totally aqueous environment at the physiological pH of 7.0. Briefly, EDAC and sulfo-NHS form an activated ester with the carboxylic acid groups of the polymer which react with the amine end of a ligand to form a peptide bond. The resulting peptide bond is resistant to hydrolysis. The use of sulfo-NHS in the reaction increases the efficiency of the EDAC coupling by a factor of ten-fold and provides for exceptionally gentle conditions that ensure the viability of the ligand-polymer complex.

Using either of these protocols it is possible to “activate” almost all polymers containing either hydroxyl or carboxyl groups in a suitable solvent system that will not dissolve the polymer matrix.

A useful coupling procedure for attaching ligands with free hydroxyl and carboxyl groups to polymers involves the use of the cross-linking agent, divinylsulfone. This method is useful for attaching sugars or other hydroxylic compounds with bioadhesive properties to hydroxylic matrices. Briefly, the activation involves the reaction of divinylsulfone to the hydroxyl groups of the polymer, forming the vinylsulfonyl ethyl ether of the polymer. The vinyl groups will couple to alcohols, phenols and even amines. Activation and coupling take place at pH 11. The linkage is stable in the pH range from 1-8.

Any suitable coupling method known to those skilled in the art for the coupling of ligands and polymers with double bonds, including the use of UV crosslinking, may be used for attachment of molecules to the polymer.

Coupling of ligands directly to polymeric particles or indirectly to polymeric particles through adaptor elements is preferably by covalent binding but it may also be indirect, for example, through a linker bound to the polymer or through an interaction between two molecules which form highly specific, non-covalent, physiochemical interactions. Suitable molecular pairs are well known in the art and include epitope/antibody, biotin/avidin, biotin/streptavidin, biotin, biotin/neutravidin, glutathione-S-transferase/glutathione, maltose binding protein/amylase and maltose binding protein/maltose. Examples of suitable epitopes which may be used for epitope/antibody pairs include, but are not limited to, HA, FLAG, c-Myc, glutathione-S-transferase, His₆, GFP, DIG, biotin and avidin. Antibodies (both monoclonal and polyclonal) which bind to these epitopes are well known in the art. Attachment of ligands to polymeric micro- and nanoparticles may also be accomplished by electrostatic attraction by dip-coating.

iv. Ligands which Function in Attachment and/or Targeting of the Particles

Targeting molecules can be proteins, peptides, nucleic acid molecules, saccharides or polysaccharides that bind to a receptor or other molecule on the surface of a targeted cell. The degree of specificity and the avidity of binding to the graft can be modulated through the selection of the targeting molecule. For example, antibodies are very specific. These can be polyclonal, monoclonal, fragments, recombinant, or single chain, many of which are commercially available or readily obtained using standard techniques.

Examples of molecules targeting extracellular matrix (“ECM”) include glycosaminoglycan (“GAG”) and collagen. In one embodiment, the external surface of polymer microparticles may be modified to enhance the ability of the microparticles to interact with selected cells or tissue. The method described above wherein an adaptor element conjugated to a targeting molecule is inserted into the particle is preferred. However, in another embodiment, the outer surface of a polymer micro- or nanoparticle having a carboxy terminus may be linked to targeting molecules that have a free amine terminus.

The choice of targeting ligand will depend on the nature of graft to be implanted. The ligand may generally increase the binding affinity of the particles for the graft or may target the nanoparticle to a particular area of the graft, such as a particular tissue in an organ or a particular cell type in a tissue. A preferred ligand is avidin. As demonstrated in Example 2 below, avidin increases the ability of polymeric nanoparticles to bind to grafts, including vascular grafts. While the exact mechanism of the enhanced binding of avidin-coated particles to vascular tissue has not been elucidated, it is hypothesized its cause to be electrostatic attraction of positively charged avidin to the negatively charged extracellular matrix of tissue. Non-specific binding of avidin, due to electrostatic interactions, has been previously documented and zeta potential measurements of avidin-coated PLGA particles revealed a positively charged surface as compared to uncoated PLGA particles.

Other useful ligands attached to polymeric micro- and nanoparticles include pathogen-associated molecular patterns (PAMPs). PAMPs target Toll-like Receptors (TLRs) on the surface of the cells or tissue, or signal the cells or tissue internally, thereby potentially increasing uptake. PAMPs conjugated to the particle surface or co-encapsulated may include: unmethylated CpG DNA (bacterial), double-stranded RNA (viral), lipopolysachamide (bacterial), peptidoglycan (bacterial), lipoarabinomannin (bacterial), zymosan (yeast), mycoplasmal lipoproteins such as MALP-2 (bacterial), flagellin (bacterial) poly(inosinic-cytidylic) acid (bacterial), lipoteichoic acid (bacterial) or imidazoquinolines (synthetic).

In another embodiment, the outer surface of the microparticle may be treated using a mannose amine, thereby mannosylating the outer surface of the microparticle. This treatment may cause the microparticle to bind to the target cell or tissue at a mannose receptor on the antigen presenting cell surface. Alternatively, surface conjugation with an immunoglobulin molecule containing an Fc portion (targeting Fc receptor), heat shock protein moiety (HSP receptor), phosphatidylserine (scavenger receptors), and lipopolysaccharide (LPS) are additional receptor targets on cells or tissue.

Lectins that can be covalently attached to micro- and nanoparticles to render them target specific to the mucin and mucosal cell layer include lectins isolated from Abrus precatroius, Agaricus bisporus, Anguilla anguilla, Arachis hypogaea, Pandeiraea simplicifolia, Bauhinia purpurea, Caragan arobrescens, Cicer arietinum, Codium fragile, Datura stramonium, Dolichos biflorus, Erythrina corallodendron, Erythrina cristagalli, Euonymus europaeus, Glycine max, Helix aspersa, Helix pomatia, Lathyrus odoratus, Lens culinaris, Limulus polyphemus, Lysopersicon esculentum, Maclura pomifera, Momordica charantia, Mycoplasma gallisepticum, Naja mocambique, as well as the lectins Concanavalin A, Succinyl-Concanavalin A, Triticum vulgaris, Ulex europaeus I, II and III, Sambucus nigra, Maackia amurensis, Limax flavus, Homarus americanus, Cancer antennarius, and Lotus tetragonolobus.

The attachment of any positively charged ligand, such as polyethyleneimine or polylysine, to any polymeric particle may improve bioadhesion due to the electrostatic attraction of the cationic groups coating the beads to the net negative charge of the mucus. The mucopolysaccharides and mucoproteins of the mucin layer, especially the sialic acid residues, are responsible for the negative charge coating. Any ligand with a high binding affinity for mucin could also be covalently linked to most microparticles with the appropriate chemistry and be expected to influence the binding of microparticles to the gut. For example, polyclonal antibodies raised against components of mucin or else intact mucin, when covalently coupled to microparticles, would provide for increased bioadhesion. Similarly, antibodies directed against specific cell surface receptors exposed on the lumenal surface of the intestinal tract would increase the residence time of beads, when coupled to microparticles using the appropriate chemistry. The ligand affinity need not be based only on electrostatic charge, but other useful physical parameters such as solubility in mucin or else specific affinity to carbohydrate groups.

The covalent attachment of any of the natural components of mucin in either pure or partially purified form to the microparticles would decrease the surface tension of the bead-gut interface and increase the solubility of the bead in the mucin layer. The list of useful ligands would include but not be limited to the following: sialic acid, neuraminic acid, n-acetyl-neuraminic acid, n-glycolylneuraminic acid, 4-acetyl-n-acetylneuraminic acid, diacetyl-n-acetylneuraminic acid, glucuronic acid, iduronic acid, galactose, glucose, mannose, fucose, any of the partially purified fractions prepared by chemical treatment of naturally occurring mucin, e.g., mucoproteins, mucopolysaccharides and mucopolysaccharide-protein complexes, and antibodies immunoreactive against proteins or sugar structure on the mucosal surface.

The attachment of polyamino acids containing extra pendant carboxylic acid side groups, e.g., polyaspartic acid and polyglutamic acid, should also provide a useful means of increasing bioadhesiveness. Using polyamino acids in the 15,000 to 50,000 kDa molecular weight range would yield chains of 120 to 425 amino acid residues attached to the surface of the microparticles. The polyamino chains would increase bioadhesion by means of chain entanglement in mucin strands as well as by increased carboxylic charge.

B. Molecules to be Delivered

Molecules to be delivered to graft materials are encapsulated within and/or attached to the polymer. Useful molecules include any molecule which inhibits rejection of the graft or aids in proper adaptation of the graft into the host. Useful molecules include proteins (including antibodies), peptides, carbohydrates, polysaccharides, nucleic acids, and organic molecules. The preferred molecules to be delivered are small molecule drugs.

Particularly preferred drugs to be delivered include immuno-suppressants, anti-inflammatories and anti-proliferatives.

Suitable immuno-suppressants include, but are not limited to, drugs acting on immunophilins, alkylating agents, antimetabolites, cytotoxic antibiotics, and IL-2 and T-cell receptor antibodies.

Drugs which act on immunophilins include the cyclosporines, tacrolimus and sirolimus (also known as rapamycin). The cyclosporines are fungal metabolites that comprise a class of cyclic oligopeptides that act as immunosuppressants. Cyclosporine A is a hydrophobic cyclic polypeptide consisting of eleven amino acids. It binds and forms a complex with the intracellular receptor cyclophilin. The cyclosporine/cyclophilin complex binds to and inhibits calcineurin, a Ca²⁺-calmodulin-dependent serine-threonine-specific protein phosphatase. Calcineurin mediates signal transduction events required for T-cell activation. Cyclosporines and their functional and structural analogs suppress the T cell-dependent immune response by inhibiting antigen-triggered signal transduction. This inhibition decreases the expression of proinflammatory cytokines, such as IL-2. Many different cyclosporines (e.g., cyclosporine A, B, C, D, E, F, G, H, and 1) are produced by fungi. Cyclosporine A is a commercially available under the trade name NEORAL from Novartis. Cyclosporine A structural and functional analogs include cyclosporines having one or more fluorinated amino acids (described, e.g., in U.S. Pat. No. 5,227,467); cyclosporines having modified amino acids (described, e.g., in U.S. Pat. Nos. 5,122,511 and 4,798,823); and deuterated cyclosporines, such as ISAtx247 (described in U.S. Patent Application Publication No. 2002/0132763 A1). Additional cyclosporine analogs are described in U.S. Pat. Nos. 6,136,357; 4,384,996; 5,284,826; and 5,709,797.

Tacrolimus (FK506) is an immunosuppressive agent that targets T cell intracellular signal transduction pathways. Tacrolimus binds to an intracellular protein FK506 binding protein (FKBP-12) that is not structurally related to cyclophilin. The FKBP/FK506 complex binds to calcineurin and inhibits calcineurin's phosphatase activity. This inhibition prevents the dephosphorylation and nuclear translocation of nuclear factor of activated T cells (NFAT), a nuclear component that initiates gene transcription required for proinflammatory cytokine (e.g., IL-2, gamma interferon) production and T cell activation. Thus, tacrolimus inhibits T cell activation. Tacrolimus is a macrolide antibiotic that is produced by Streptomyces tsukubaensis. Tacrolimus and tacrolimus analogs are described by Tanaka et al., (J. Am. Chem. Soc., 109:5031, 1987) and in U.S. Pat. Nos. 4,894,366, 4,929,611, and 4,956,352. FK506-related compounds, including FR-900520, FR-900523, and FR-900525, are described in U.S. Pat. No. 5,254,562; O-aryl, O-alkyl, O-alkenyl, and O-alkynylmacrolides are described in U.S. Pat. Nos. 5,250,678, 532,248, 5,693,648; amino O-aryl macrolides are described in U.S. Pat. No. 5,262,533; alkylidene macrolides are described in U.S. Pat. No. 5,284,840; N-heteroaryl, N-alkylheteroaryl, N-alkenylheteroaryl, and N-alkynylheteroaryl macrolides are described in U.S. Pat. No. 5,208,241; aminomacrolides and derivatives thereof are described in U.S. Pat. No. 5,208,228; fluoromacrolides are described in U.S. Pat. No. 5,189,042; amino O-alkyl, O-alkenyl, and O-alkynylmacrolides are described in U.S. Pat. No. 5,162,334; and halomacrolides are described in U.S. Pat. No. 5,143,918.

Rapamycin is a cyclic lactone produced by Streptomyces hygroscopicus. Rapamycin is an immunosuppressive agent that inhibits T cell activation and proliferation. Like cyclosporines and tacrolimus, rapamycin forms a complex with the immunophilin FKBP-12, but the rapamycin-FKBP-12 complex does not inhibit calcineurin phosphatase activity. The rapamycin immunophilin complex binds to and inhibits the mammalian kinase target of rapamycin (mTOR). mTOR is a kinase that is required for cell-cycle progression. Inhibition of mTOR kinase activity blocks T cell activation and proinflammatory cytokine secretion. Rapamycin structural and functional analogs include mono- and diacylated rapamycin derivatives (U.S. Pat. No. 4,316,885); rapamycin water-soluble prodrugs (U.S. Pat. No. 4,650,803); carboxylic acid esters (PCT Publication No. WO 92/05179); carbamates (U.S. Pat. No. 5,118,678); amide esters (U.S. Pat. No. 5,118,678); biotin esters (U.S. Pat. No. 5,504,091); fluorinated esters (U.S. Pat. No. 5,100,883); acetals (U.S. Pat. No. 5,151,413); silyl ethers (U.S. Pat. No. 5,120,842); bicyclic derivatives (U.S. Pat. No. 5,120,725); rapamycin dimers (U.S. Pat. No. 5,120,727); O-aryl, O-alkyl, O-alkyenyl and O-alkynyl derivatives (U.S. Pat. No. 5,258,389); and deuterated rapamycin (U.S. Pat. No. 6,503,921). Additional rapamycin analogs are described in U.S. Pat. Nos. 5,202,332 and 5,169,851.

Suitable alkylating agents include, but are not limited to, nitrogen mustards (cyclophosphamide), nitrosoureas, platinum compounds and others.

Antimetabolites interfere with the synthesis of nucleic acids. Suitable immunosuppresive antimetabolites include folic acid analogues, such as methotrexate, purine analogues such as azathioprine and mercaptopurine, pyrimidine analogues and protein synthesis inhibitors. Methotrexate is a folic acid analogue. It binds dihydrofolate reductase and prevents synthesis of tetrahydrofolate. Azathioprine, is the main immunosuppressive cytotoxic substance. It is nonenzymatically cleaved to mercaptopurine, that acts as a purine analogue and an inhibitor of DNA synthesis.

Suitable cytotoxic antibiotics include, but are not limited to, dactinomycin, anthracyclines, mitomycin C, bleomycin and mithramycin. Anti-inflammatory agents suitable for use include steroidal anti-inflammatory drugs, including glucocorticoids which reduce inflammation by binding to cortisol receptors. Examples of suitable glucocorticoids include, but are not limited to, alclometasone, aldosterone, amcinonide, beclometasone, betamethasone, budesonide, ciclesonide, clobetasol, clobetasone, clocortolone, cloprednol, cortisone, cortivazol, deflazacort, deoxycorticosterone, desonide, desoximetasone, desoxycortone, dexamethasone, diflorasone, diflucortolone, difluprednate, fluclorolone, fludrocortisone, iludroxycortide, flumetasone, flunisolide, fluocinolone acetonide, fluocinonide, fluocortin, fluocortolone, fluorometholone, fluperolone, fluprednidene, fluticasone, formocortal, halcinonide, halometasone, hydrocortisone/cortisol, hydrocortisone aceponate, hydrocortisone buteprate, hydrocortisone butyrate, loteprednol, medrysone, meprednisone, methylprednisolone, methylprednisolone aceponate, mometasone furoate, paramethasone, prednicarbate, prednisone, prednisolone, prednylidene, rimexolone, tixocortol, triamcinolone and ulobetasol.

Other anti-inflammatory agents which are suitable for use include non-steroidal anti-inflammatory drugs (NSAIDs). Examples of suitable NSAIDs include, but are not limited to, naproxen sodium, diclofenac sodium, diclofenac potassium, aspirin, sulindac, diflunisal, piroxicam, indomethacin, ibuprofen, nabumetone, choline magnesium trisalicylate, sodium salicylate, salicylsalicylic acid (salsalate), fenoprofen, flurbiprofen, ketoprofen, meclofenamate sodium, meloxicam, oxaprozin, sulindac, tolmetin, rofecoxib, celecoxib, valdecoxib, and lumiracoxib.

C. Carriers

Typically the microparticles or nanoparticles will be formulated in sterile saline or buffered solution for injection into the tissues or cells to be treated. The particles can be stored lyophilized in single use vials for rehydration immediately before use. Other means for rehydration and administration are known to those skilled in the art.

### III. Methods for Attachment of Micro- and Nanoparticles to Graft Materials Ex Vivo

Graft materials are treated with drug-loaded micro- or nanoparticles prior to implantation. The particles are applied to the tissue by methods to insure that they adhere and are distributed throughout the tissue in optimal locations for drug treatment. The design of the particle insures that 1) they adhere to the regions of interest, 2) they carry sufficient drug load to provide local treatment for prolonged periods, 3) they release the drug load at the proper rate, and 4) they penetrate into tissue to an optimal extent. The surgeon can then apply a long-term, local drug regimen at the same time the tissue or organ is placed in the patient.

The graft material is treated with drug-loaded micro- or nanoparticles prior to implantation. The amount of polymeric particles present on the graft tissue and the penetration of particles throughout the tissue can be adjusted. In this way the amount of drug locally release at the site of implantation can be carefully controlled. Particles are attached to the graft material by incubation of the particles with the graft material either in the absence or presence of mild agitation. Agitation may be accomplished for example, by incubation on an orbital shaker, or by vertical rotation, such as by incubation in a vertical carousel of a hybridization oven. The incubation protocol can be varied to affect the positioning of the particles on the graft. The amount and localization of attachment of particles to the graft can also be varied by varying the type and density of attachment and targeting ligands, such as those described above, presented on the particles.

### IV. Applications for Methods for Administration of Drugs to Grafts

A. Inhibition of Hyperplasia and Stenosis of Vascular Grafts

Arterial restenosis is the occlusion or constriction of an artery after prior opening by surgical procedure. Neointimal hyperplasia, the proliferation of vascular smooth muscle cells, is a major contributor to vessel restenosis and the principal cause of failure in late bypass grafts and arteriovenous graft fistulas used for permanent renal dialysis access. Hyperplasia begins immediately upon injury at the site of injury and is characterized by smooth muscle cell and fibroblast proliferation, microvessel formation, and matrix deposition.

The treatment of restenosis requires additional, generally more invasive, procedures, including coronary artery bypass graft (CABG) in severe cases. Consequently, methods for preventing restenosis, or treating incipient forms, are being aggressively pursued. In 1973 an immunosuppressive drug called rapamycin (also known as sirolimus) was discovered and subsequently introduced clinically to mitigate the immune rejection of organs after transplantation and is still widely used today.

One method for preventing restenosis is the administration of anti-inflammatory compounds that block local invasion/activation of monocytes thus preventing the secretion of growth factors that may trigger SMC proliferation and migration. Other potentially anti-restenotic compounds include antiproliferative agents that can inhibit SMC proliferation, such as rapamycin and paclitaxel. Rapamycin is generally considered an immunosuppressant best known as an organ transplant rejection inhibitor. However, rapamycin is also used to treat severe yeast infections and certain forms of cancer. Although the mechanism of rapamycin is not completely understood, it is known that the mammalian target of rapamycin (mTOR), a critical component in the signaling pathway that regulates cell growth, is tightly bound by rapamycin (after forming a complex with FK506 binding protein), thus inhibiting its signaling function and/or cellular proliferation. Vascular grafts suffer from significant levels of neointimal hyperplasia. It has been reported that applying rapamycin to vascular grafts at the time of implantation significantly decreases the occurrence of neointimal hyperplasia. Paclitaxel, known by its trade name Taxol®, is used to treat a variety of cancers, most notably breast cancer.

The delivery of rapamycin and other antiproliferative drugs to vascular grafts could be an effective method of controlling neointimal hyperplasia, and current evidence suggests that a course of treatment early after implantation can have long-term beneficial effects. Unfortunately, the systemic delivery of this drug can cause immune suppression. Also, anti-inflammatory and antiproliferative compounds can be toxic when administered systemically in anti-restenotic-effective amounts. Furthermore, the exact cellular functions that must be inhibited and the duration of inhibition needed to achieve prolonged vascular patency (greater than six months) are not presently known. Moreover, it is believed that each drug may require its own treatment duration and delivery rate. Therefore, in situ, or site-specific drug delivery using anti-restenotic coated stents has become the focus of intense clinical investigation. Recent human clinical studies on stent-based delivery of rapamycin and paclitaxel have demonstrated excellent short-term anti-restenotic effectiveness. Stents, however, have drawbacks due to the very high mechanical stresses, the need for an elaborate procedure for stent placement, and manufacturing concerns associated with expansion and contraction.

The methods described herein can be used to locally deliver anti-restenotic agents to grafts without the requirement for further invasive procedures, such as placement of a stent. This method can be used to prevent or reduce restonosis in a variety of vascular grafts, including, but not limited to, bypass grafts and arteriovenous grafts.

i. Bypass Graft

A common form of bypass surgery involves resecting the saphenous vein from the leg for autotransplantation to the coronary artery. In a significant number of cases these grafts fail, largely due to restenosis caused by neointimal hyperplasia. The methods described herein can be used to deliver rapamycin or another anti-restenotic agent locally and in a controlled fashion to, to the autologous graft. The application of these drug-loaded micro- and nanoparticles can be done during surgery. After resection of the saphenous vein the tissue can be (and is often for hours) suspended in saline during chest opening and preparation for graft implantation. Drug-loaded micro- or nanoparticles can be incubated with the saphenous vein during this time period which is sufficient for attachment.

iI. Arteriovenous Graft

End stage renal disease is increasing in the United States, with 19.3 billion dollars spent on 375,000 patients in 2000. Morbidity of hemodialysis access remains a major quality of life issue for patients; it also represents a significant cost to society. A native arteriovenous fistula (AVF) remains the conduit of choice to provide access for hemodialysis and provides superior results when compared with other options such as a prosthetic AVG. Unfortunately each individual is limited in the number of native AVF that can be created due to the limited number of suitable sites and vessels. Access sites are limited as patients with end stage renal disease usually have severe comorbidity, requiring extensive venipuncture for diagnosis and therapy for life. In patients who have exhausted all options for primary AVF, new access sites must use AV grafts; these grafts are susceptible to restenosis by neointimal hyperplasia limiting their effectiveness. Incubation of drug-loaded micro- and nanoparticles onto the graft can be done at the time of surgery.

B. Inhibition of Rejection of Allografts, Xenografts, Synthetic Grafts and Tissue Engineered Grafts by Local Immuno-Suppression

Graft versus host disease is a condition that develops following graft transplantation in which functional immune cells in the transplanted graft recognize the recipient as “foreign” and mount an immunologic attack. Elimination of those functional cells which primarily involve dendritic cells and other antigen-presenting cells may eliminate this disease after organ transplantation.

The use of cyclosporine (beginning in the 1980's) and newer, more powerful drugs such as tacrolimus and mycophenolate have decreased the incidence of acute and chronic transplant rejection (Hariharan, et al., N. Engl. J. Med., 342(9):605-12 (2000)). Cyclosporin can be delivered orally by nano/microspheres made from sodium lauryl sulfate-dextrin, poly(isobutyl-2-cyanoacrylate), polycaprolactone (“PCL”), and poly(lactide-co-glycolide)-polyethyleneglycol (“PLGA-PEG”), and with lipospheres, and micelles. It can also be delivered intra-parenterally in liposomes, micelles, polyethyleneoxide-b-polycaprolactone (“PEO-b-PCL”) micelles, and with PLA, and PLA-PCL microspheres or ocularly by micelles, anionic microemulsions, cationic microemulsions, PCL nanocapsules, chitosan nanoparticles, PLGA microspheres, biodegradable implants of PLGA and nonbiodegradable implants (Italia, et al., Drug Discov. Today, 11(17-18):846-54 (2006)).

While it may be important to suppress the immune response to allografts systemically long-term to prevent chronic rejection, it is understood that initial acute rejection originates at the site of transplantation, thus immunosuppresion at the site of transplantation can decrease levels of rejection facilitating long-term acceptance and a lessening of rejection severity. This is because rejection originates at the level of the transplanted organ.

Rejection is the consequence of the recipient's alloimmune response to the non-self antigens expressed by donor tissues. In hyperacute rejection, transplant subjects are serologically presensitized to alloantigens (i.e., graft antigens are recognized as nonself). Histologically, numerous polymorphonuclear leukocytes (PMNs) exist within the graft vasculature and are associated with widespread microthrombin formation and platelet accumulation. Little or no leukocyte infiltration occurs. Hyperacute rejection manifests within minutes to hours of graft implantation.

In acute rejection, graft antigens are recognized by T cells; the resulting cytokine release eventually leads to tissue distortion, vascular insufficiency, and cell destruction. Histologically, leukocytes are present, dominated by equivalent numbers of macrophages and T cells within the interstitium. These processes can occur within 24 hours of transplantation and occur over a period of days to weeks.

In chronic rejection, pathologic tissue remodeling results from peritransplant and posttransplant trauma. Cytokines and tissue growth factor induce smooth muscle cells to proliferate, to migrate, and to produce new matrix material. Interstitial fibroblasts are also induced to produce collagen. Histologically, progressive neointimal formation occurs within large and medium arteries and, to a lesser extent, within veins of the graft. Leukocyte infiltration usually is mild or even absent. All these result in reduced blood flow, with subsequent regional tissue ischemia, fibrosis, and cell death.

The methods descried herein can be used to prevent rejection of grafts by locally releasing immunosuppressive drugs at the site of implantation. The methods can be used to prevent rejection of many types of grafts, including allografts, xenografts, synthetic grafts and tissue engineered grafts. The local release of immunosupressants achieved by the disclosed methods reduces the immune response at the site of implantation without reducing the systemic immune response. While it may be important to suppress the immune response to allografts systemically long-term as in chronic rejection, it is understood that initial acute rejection originates at the site of transplantation, thus immunosuppresion at the site of transplantation can decrease levels of rejection facilitating long-term acceptance and a lessening of rejection severity.

Graft versus host disease is a condition where is graft transplantation in which functional immune cells in the transplanted graft recognize the recipient as “foreign” and mount an immunologic attack. Elimination of those functional cells which primarlily involve dendritic cells and other antigen-presenting cells may eliminate this disease after organ transplantation. The methods dsclosed herein may be used to clear allogenic cells and thereby extend the life-time of the graft or decreasing the severity of the rejection episodes and the associated drug dose that is used to treat rejection.

### EXAMPLES

### Example 1

### Controlled Release of Drugs from Nanoparticles

Materials and Methods:

Five milligrams of rapamycin-loaded nanospheres were placed in 18 different tubes and suspended in 0.5 mls of phosphate buffered saline. The tubes were then incubated at 37° C. on a rotary shaker. At various time points, three of the tubes were removed and centrifuged to pellet the nanospheres. The supernatant was discarded and the nanospheres dissolved in NaOH to release all of the encapsulated rapamycin. The amount of released rapamycin was measured by absorption at 290 nm and converted to micrograms from a standard curve. This value, rapamycin remaining in the particles after PBS incubation, was then subtracted from the total amount of rapamycin encapsulated to yield the total amount released at that time point.

The bioactivity of the released rapamycin was then determined by PBMC assay. Briefly, PBMC cells were stimulated with IL-12 and IL-18. The levels of interferon released from PBMC cells were measured by ELISA assays.

Results:

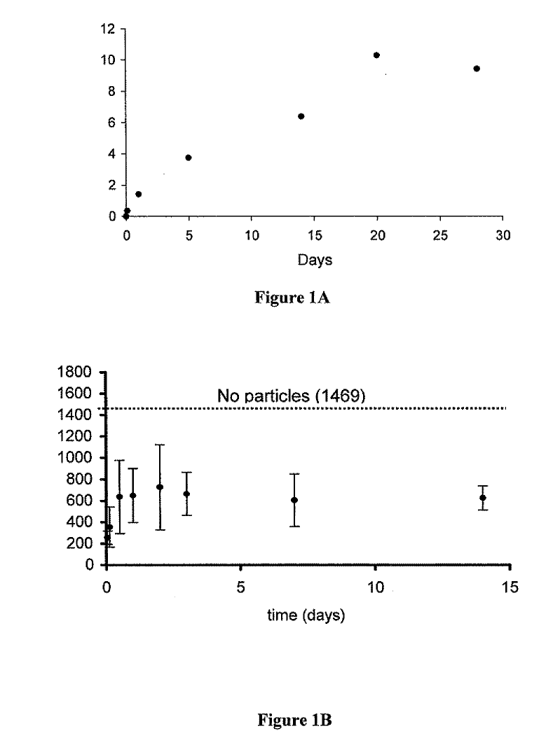

Rapamycin was steadily released from nanoparticles over the course of twenty days (FIG. 1A). The interferon levels released from IL-12 and IL-18-stimulated PBMC cells decreased when incubated in rapamycin released from the nanospheres (FIG. 1B).

### Example 2

### Localized Coating of Vascular Grafts with Nanoparticles

Materials and Methods:

Rhodamine-loaded nanoparticles were used to demonstrate attachment (and impregnation) of nanoparticles to vascular wall of a human saphenous vein. Vascular grafts were either not coated, lumen- or intima-coated, adventia-coated, or both intima- and adventia-coated. To coat the vascular grafts 5 mgs of avidin-coated rhodamine nanoparticles were placed in a 5 ml scinillation vial and then suspended in a solution of Pluronic F-127 (300 μl of 10% Pluronic in DMSO and 2700 μl of PBS). The glass vial was then fixed to a vertical carousel of a hybridization oven and mixed for 20 minutes (maximal RPM, 25° C.). Parafilm was used to cover the portion of the vessel not to be coated.

Results:

Rhodamine nanoparticles were clearly visible in the intima of the graft which was intima-coated and likewise in the adventia of the graft which was adventia-coated. A greater degree of attached rhodamine nanoparticles were visible in the graft where the vessel was coated on both sides, including migration of the particles into the vessel wall. Additionally, digital photography showed that it was possible to coat the graft in a highly specific geometric pattern as visible by a ‘stripe’ of avidin nanoparticles coating the artery.

### Example 3

### Amount of Coating of Vascular Grafts with Nanoparticles

Materials and Methods:

Two different sizes of ovine vascular tissue, 30 mm² (n=3) and 10 mm² (n=3), were coated with rhodamine nanoparticles and evaluated for amount of bound nanoparticles. The tissues were either coated with avidin rhodamine nanospheres or blank rhodamine nanospheres. After coating, the pieces of tissue were rinsed in distilled water three times, frozen and lyophilized. After two days the tissue was removed from the lyophilizer and suspended in 0.5 ml of DMSO for 4 hours to dissolve the nanospheres, thereby releasing the encapsulated rhodamine. The 0.5 ml of DMSO was then removed from the tissue and mixed with 0.5 ml of distilled water. This mixture was allowed to set for 30 minutes and then centrifuged to remove any precipitated polymer or loose tissue, and then scanned for fluorescence (ex. 550, em. 580). The resultant value was used to calculate the amount of particles attached.

Results:

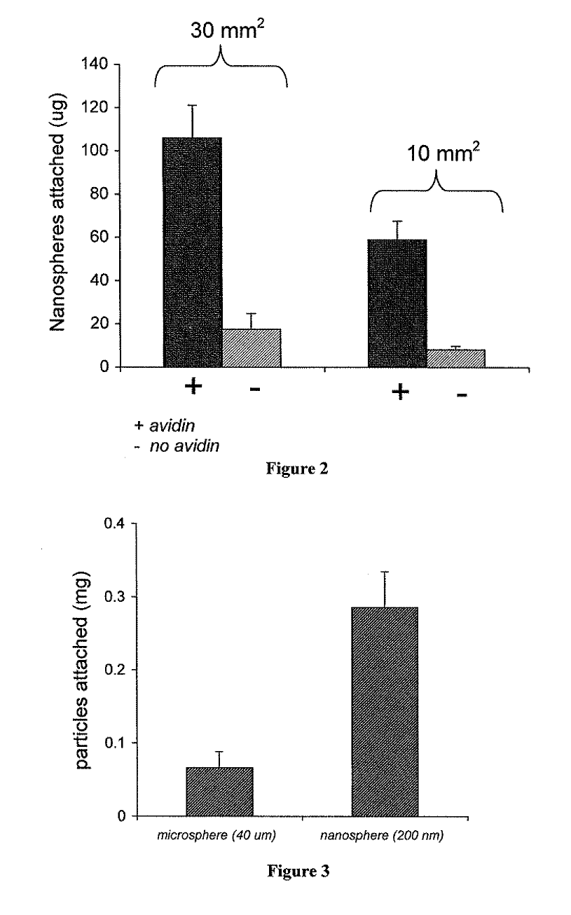

A greater amount of rhodamine nanoparticles were bound to the larger size of ovine vascular tissue (FIG. 2). Additionally, the amount of avidin-coated rhodamine nanoparticles bound to the tissue was approximately 6 times greater than the amount of non-coated rhodamine nanoparticles (FIG. 2).

### Example 4

### Effect of Particle Diameter on the Attachment of Avidin-Coated Particles to Vascular Tissue

Materials and Methods:

Avidin-coated microparticles (40 μm) and nanoparticles (200 nm) were incubated with vascular tissue (8 mm²). Five mgs of particles were suspended in one mL of phosphate buffered saline in a 10 ml glass scintillation vile. The size of the vile used can be altered depending on the geometry and size of the tissue being coated, as can the volume of particle solution, however, there should be sufficient volume to completely immerse the tissue. The vile was then fixed to a vertically rotating carousel of a hybridization oven (a vertically rotating shaft can work as well) and agitated for 20 minutes at approximately 50 rpm's. Pluronic F127 can be added to the solution if particles aggregate or do not disperse.

The amount of attached particles was then determined. Fluorescent, avidin-coated, rhodamine nanoparticles were used to quantitate the amount of particles attached to tissue. After coating the tissue with rhodamine nanoparticles (as described above) the tissue was rinsed three times and immersed in 500 μl of DMSO. After three hours of soaking, the tissue was removed from DMSO and mixed with equal parts water. The addition of water was required as rhodamine does not fluoresce in pure DMSO. The DMSO/water solution was centrifuged at 10,000 rpm's for 10 minutes, filtered with a 0.22 μm syringe filter and its fluorescence measured (ex. 550, em. 580). This fluorescence was then compared to a fluorescent calibration curve generated from variable amounts of the same particles.

Results:

Avidin-coated nanoparticles of 200 nm in diameter demonstrated greater attachment to vascular tissue than avidin-coated microparticles of 40 μm in diameter (FIG. 3).

### Example 5

### Effect of Method of Exposure of Avidin-Coated Particles to Vascular Tissue on the Amount of Attachment

Materials and Methods:

Avidin-coated nanoparticles were exposed to vascular tissue (15 mm²) with either no agitation or gentle agitation using either an orbital shaker or vertical rotation. The amount of attached particles was then determined.

Results:

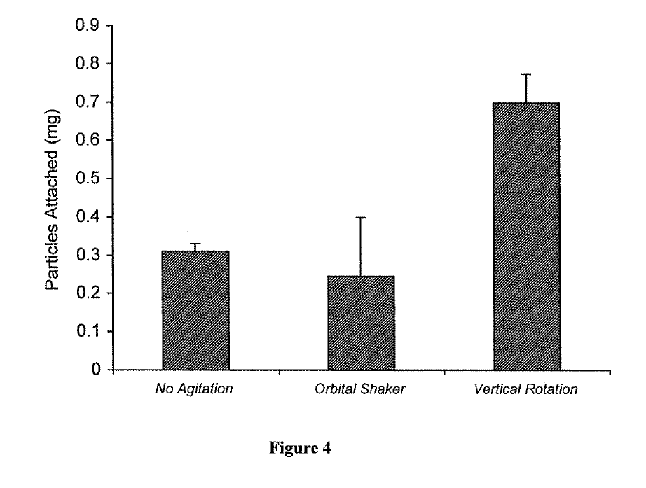

Incubation of avidin-coated nanoparticles with vascular tissue using vertical rotation resulted in a greater amount of attached particles as opposed to either no agitation or agitation using an orbital shaker (FIG. 4).

### Example 6

### In Vivo Demonstration of Nanoparticle Efficacy in Preventing Hyperplasia of Vascular Grafts

Materials and Methods:

The following experiments were performed with the rapamycin nanoparticles described in Example 1 above. In these experiments an aged rat model was used to verify the efficacy of the rapamycin eluting particles in vivo. Briefly, an aged Fisher 344 rat was anesthetized with ketamine and its jugular vein resected (approximately 10 cm in length). The jugular vein graft was then placed in a 5 ml scinillation vial, along with 5 mg's of avidin-coated rapamycin nanoparticles and a solution of Pluronic F-127 (300 μl of 10% Pluronic in DMSO and 2700 μl of PBS). The glass vial was then fixed to a vertical carousel of a hybridization oven and mixed for 20 minutes (maximal RPM, 25° C.). After coating, the graft was micro-surgically implanted into the carotid artery of the Fisher 344 rat and the rat survived. After 3 weeks, the graft was resected and histologically evaluated (hemotoxylin and eosin and trichrome). It should be noted, the rapamycin nanoparticle tissue was not perfusion fixed.

Results:

The untreated graft had significant hyperplasia while the graft coated with rapamycin nanoparticles showed only a monolayer of endothelial cells thus demonstrating the efficacy of the rapamycin nanoparticles in preventing hyperplasia of the jugular vein graft.

### Example 7

### Attachment of Ligands to Medical Device Surface

### Optimized Condition for Nanoparticles Adsorption

Fluorescent and scanning electron micrographs of PLGA particles adsorbed to polylysine treated silicon chip. Compared to pH 7.4, 1 mM NaCl, 10 mM HEPES buffer solution, the higher 100 mM NaCl condition resulted in more particle attachment. From density count, there was more than three folds of increase in adsorption with the lesser charged condition.

It is understood that the disclosed invention is not limited to the particular methodology, protocols, and reagents described as these may vary. It is also to be understood that the terminology used herein is for the purpose of describing particular embodiments only, and is not intended to limit the scope of the present invention which will be limited only by the appended claims. Those skilled in the art will recognize, or be able to ascertain using no more than routine experimentation, many equivalents to the specific embodiments of the invention described herein. Such equivalents are intended to be encompassed by the following claims.

1. A method of prevention of graft rejection comprising contacting graft materials ex vivo with polymeric micro- or nanoparticles targeted with a tissue specific ligand which deliver a locally high density of a therapeutic or prophylactic agent selected from the group consisting of immunosupressants, anti-proliferatives and anti-inflammatory factors in an amount effective to decrease the immune response of a host to the graft following implantation.

2. The method of claim 1 wherein the agent is incorporated in a high density on or within the particles, and
wherein the particles comprising ligands present in a density of between about which is preferably in the range of 1,000 to 10,000,000, ligands per square micron of particle surface area.

3. The method of claim 1 wherein the ligands have a first end incorporated into the surface of the particle and a second end facing outwardly from the surface of the particle.

4. The method of claim 3 wherein the polymer is a hydrophobic polymer and the ligands are materials with an HLB of less than 10, more preferably less than 5, which insert into the surface of the particles.

5. The method of claim 4 comprising a hydrophobic polymer having fatty acid conjugates inserted therein and extending outwardly from the polymeric surface.

6. The method of claim 1 wherein the ligands are, or are bound to, an agent to be delivered selected from the group consisting of therapeutic, nutritional, diagnostic, and prophylactic agents, attachment molecules, targeting molecules, and mixtures thereof.

7. The method of claim 1 wherein targeting molecules are bound to the surface of the particles or to the ligands.

8. The method of claim 1 wherein the targeting molecules are selected from the group consisting of specific targeting molecules and non-specific targeting molecules.

9. The method of claim 11 wherein the density and means of attachment, whether covalent or ionic, direct or via the means of linkers, of the ligands is used to modulate targeting and penetration of the particles.

10. The method of claim 1 wherein the targeting molecules are selected from the group consisting of antibodies and fragments thereof, sugars, peptides, and ligands for cell surface receptors.

11. The method of claim 1 wherein the ligands are attachment molecules.

12. The method of claim 14 wherein the ligand is, or is bound to, an attachment molecule selected from the group consisting of strepavidin, neuavidin, avidin, and biotin.

13. The method of claim 1 further comprising linkers attached to the ligands.

14. The method of claim 13 wherein the linkers are branched and multiple agents to be delivered or attachment molecules are attached via the linkers to each of the ligands.

15. The method of claim 14 wherein the linkers are polyethyleneglycol star polymers.

16. The method of claim 15 wherein the linkers are polyethyleneglycol and the attachment molecules are strepavidin, neuavidin, avidin or biotin.

17. The method of claim 1 wherein the particles have a diameter that is between 0.5 and 20 microns.

18. The method of claim 1 in the form of nanoparticles having a diameter between 50 and 1000 nanometers.

19. The method of claim 18 wherein the nanoparticles have a diameter of between 50 and 100 nm.

20. The method of claim 1 wherein the particles are encapsulated in a liposome.

21. The method of claim 1 wherein the particles are formed by providing a solution of a hydrophobic polymer or the polymer in liquid form, adding materials with an HLB of less than 10, more preferably less than 5, to the polymer, which insert into the surface of the particles wherein when the polymer is solidified to form particles under conditions wherein one end of the material with an HLB of less than 10 inserts into the polymer and the other end extends outwardly from the polymeric surface of the particle.

22. The method of claim 21 wherein the hydrophobic polymer and material with an HLB of less than 10 are added to the polymer in a water-in oil-in-water emulsion.

23. The method of claim 21 wherein the material with an HLB of less than 10 is first conjugated to a targeting or attachment molecule or therapeutic, prophylactic or diagnostic agent.

24. The method of claim 21 wherein the material with an HLB of less than 10 is a fatty acid, lipid or detergent.

25. The method of claim 1 wherein the graft or a device for implantation as a graft into tissue is treated prior to implantation.

26. The method of claim 1 administered to a vascular graft in an amount effective to inhibit hyperplasia and stenosis or other maladaptation of vascular grafts.

27. The method of claim 26 wherein the graft is a bypass graft or arteriovenous graft.
